(19) United States
(12) Patent Application Publication
(10) Pub. No.: US 2011/0217218 A1
(43) Pub. Date: Sep. 8, 2011

(54) Systems and Methods for Acid Gas Removal

(75) Inventors: Ramesh Gupta, Berkeley Heights, NJ (US); Krishnan Sankaranarayanan, South Riding, VA (US); Himanshu Gupta, Lorton, VA (US); Benjamin A. McCool, Bonita Springs, FL (US); Robert B. Fedich, Long Valley, NJ (US); Richard D. Lenz, Centreville, VA (US)

(73) Assignee: EXXONMOBIL RESEARCH AND ENGINEERING COMPANY, Annandale, NJ (US)

(21) Appl. No.: 13/030,576

(22) Filed: Feb. 18, 2011

Related U.S. Application Data
(60) Provisional application No. 61/339,224, filed on Mar. 2, 2010.

(51) Int. Cl. B01D 53/62; B01D 53/52

(52) U.S. Cl. 423/228

(57) ABSTRACT

A method and system for the selective removal of CO₂ and/or H₂S from a gaseous stream containing one or more acid gases. In particular, a system and method for separating CO₂ and/or H₂S from a gas mixture containing an acid gas using an absorbent solution and one or more ejector venturi nozzles in flow communication with one or more absorbent contactors. The method involves contacting a gas mixture containing at least one acid gas with the absorbent solution under conditions sufficient to cause absorption of at least a portion of said acid gas. The absorbent contactors operate in co-current flow and are arranged in a counter-current configuration to increase the driving force for mass transfer. Monoliths can be used that operate in a Taylor flow or slug flow regime. The absorbent solution is treated under conditions sufficient to cause desorption of at least a portion of the acid gas.

### CROSS REFERENCE TO RELATED APPLICATION

This Non-Provisional Application claims the benefit of U.S. Provisional Application No. 61/339,224 filed Mar. 2, 2010, the entire contents and substance of which are hereby incorporated by reference as if fully described and set forth herein.

### FIELD OF THE DISCLOSURE

This disclosure generally relates to the selective removal of CO₂ and/or other acid gases from a gaseous stream containing one or more of these gases. In particular, this disclosure relates to low capital investment systems and methods for separating an acid gas from a gas mixture using an absorbent solution and one or more liquid spray devices in flow communication with one or more absorbent contactors. The absorbent solution can be treated under conditions sufficient to cause desorption of at least a portion of the acid gas.

### DISCUSSION OF THE BACKGROUND ART

Global climate change concerns may necessitate capture of CO₂ in flue gases and other process streams. Conventional methods for CO₂ capture include cryogenic distillation/condensation, absorption using liquid solvents, such as amine scrubbing, or sorption using solid sorbents, such as pressure swing absorption (PSA) and/or temperature swing absorption (TSA). A prevalent option for separating CO₂ from flue gases or other acid gas streams is scrubbing the gas stream using liquid amine sorbent molecules dissolved in water. These aqueous amine solutions chemically trap the CO₂ via formation of one or more ammonium salts (carbamate/bicarbonate/carbonate). These salts are thermally unstable, enabling the regeneration of the free amine at elevated temperatures.

All of these technologies require a relatively low temperature of the gas stream to enable CO₂ condensation or sorption. Conventional methods (PSA, TSA, and amine scrubbing) require CO₂ uptake at relatively low temperatures (e.g., less than about 50° C.). Sorbent/solvent regeneration (CO₂ desorption) is accomplished by a step change decrease in CO₂ partial pressure (PSA), and/or by a temperature increase to above about 100° C. (TSA, amine scrubbing). In all of these cases, CO₂ capture costs depend significantly on the required heat exchange capacities for gas cooling/heating, steam generation for CO₂ desorption and CO₂ recompression costs.

Amine scrubbing is based on the chemistry of CO₂ with amines to generate carbonate/bicarbonate and carbamate salts. Commercially, amine scrubbing typically involves contacting the CO₂ and/or H₂S containing gas stream with an aqueous solution of one or more amines (e.g., monoethanolamine). The process requires high rates of gas-liquid exchange and the transfer of large liquid inventories between the absorption and regeneration steps and high energy (heating/cooling) requirements for the regeneration of amine solutions. This process is challenged by the corrosive nature of the amine solutions. These challenges limit its economic viability for large-scale applications (e.g., large combustion sources and power plants).

Aqueous amine scrubbing is economically practiced at small to medium process scales, however, the possibility that the large-scale capture of CO₂ from furnaces may soon be mandated and create scenarios where current amine scrubbing technology is economically challenged. The relatively high cost of aqueous amine scrubbing on large volumes of dilute gas results from the need to heat and cool large volumes of solution resulting in large gas-liquid contactor and amine regeneration vessels. Combined with the high corrosivity of the CO₂/amine/water medium, the metallurgical costs for these large vessels become prohibitive. Downstream fouling of process equipment can also become problematic. Finally, the high latent heat of vaporization of water in aqueous absorbent systems greatly increases the energy required to heat the aqueous solution to the required regeneration temperature.

The growing need to incorporate carbon capture and sequestration (CCS) into fossil fuel-based power generation, has triggered accelerating research into alternatives to conventional CO₂ removal technology. Cyclic absorption technologies (e.g., PSA and TSA) using solid absorbents are also used in the gas purification industry. These processes avoid many of the limitations of amine scrubbing described above, but suffer from a lack of absorbents having sufficient CO₂ adsorption capacities as well as lacking sufficiently selective CO₂ absorption characteristics under the humid conditions always present in combustion flue gas.

Because of the very large volumes of the flue gases from refineries or power plants, use of traditional processes become prohibitively large and expensive. For example, it is estimated that multiple very large absorption towers, each exceeding 40 feet in diameter, would be needed to handle the several million cubic feet per hour of flue gas from a refinery or power plant. Additionally, expensive blower fans would be needed to draft the flue gas through the amine contactors. Since, the required capital investment is a large fraction of the CO₂ capture costs, a more compact and less expensive CO₂/amine process is highly desirable. In addition, if anticipated future restrictions on CO₂ emissions are mandated, a low cost method for CO₂ capture will be a critical need as a part of CCS.

Carbon dioxide is a ubiquitous and inescapable by-product of the combustion of hydrocarbons. There is growing concern over CO₂ accumulation in the atmosphere and its role in global climate change. Therefore, in addition to the commercial benefits of CO₂ recovery, environmental factors may soon require its capture and sequestration. For these reasons, the separation of CO₂ from mixed gas streams is a rapidly growing area of research.

Therefore, a need exists for developing commercially viable alternative methods for the selective removal of CO₂ from gas mixtures, especially alternative methods having economic viability for large-scale applications for CO₂ removal (e.g., large combustion sources and power plants).

### SUMMARY OF THE DISCLOSURE

In a preferred embodiment of the present invention, is a method of separating an acid gas component from a feed gas mixture comprising an acid gas, such method comprising:

providing at least one liquid spray device in flow communication with at least one absorbent contactor, and at least one gas feed inlet line in flow communication with said at least one absorbent contactor, wherein said absorbent contactor is comprised of a at least one of a monolithic or packed bed;

contacting in said absorbent contactor in co-current flow at least a portion of a feed gas mixture containing at least one acid gas with at least a portion of a first absorbent solution under conditions sufficient to cause absorption of at least a portion of said acid gas, wherein said acid gas is comprised of CO₂, H₂S or a combination thereof;

removing a first partially scrubbed gas mixture from said absorbent contactor, wherein the molar concentration of acid gas in said first partially scrubbed gas mixture is less than the molar concentration of said acid gas in said feed gas mixture; and

removing a stream of a first spent absorbent solution from said absorbent contactor, which first spent absorbent solution contains at least a portion of the acid gas from the feed gas mixture.

Another preferred embodiment is a method of separating an acid gas component from a feed gas mixture comprising and acid gas, such method comprising:

providing at least a first ejector venturi nozzle in flow communication with at least a first absorbent contactor, and at least a second ejector venturi nozzle in flow communication with at least a second absorbent contactor; said first absorbent contactor in flow communication with said second ejector venturi nozzle and said second absorbent contactor in flow communication with said first ejector venturi nozzle;

ejecting a first ejector stream comprising liquid droplets from said first ejector venturi nozzle into said first absorbent contactor, said first ejector stream comprising a first absorbent solution and a first feed gas mixture containing at least one acid gas;

contacting in said first absorbent contactor in co-current flow at least a portion of said first feed gas mixture containing at least one acid gas with at least a portion of said first absorbent solution under conditions sufficient to cause absorption of at least a portion of said acid gas, wherein said acid gas is comprised of CO₂, H₂S or a combination thereof;

removing a first partially scrubbed gas mixture from said first absorbent contactor, wherein the molar concentration of said acid gas in said first partially scrubbed gas mixture is less than the molar concentration of said acid gas in said first feed gas mixture;

ejecting a second ejector stream comprising liquid droplets from said second ejector venturi nozzle into said second absorbent contactor, said second ejector stream comprising a second absorbent solution and a second feed gas mixture containing at least a portion of said first partially scrubbed gas mixture from said first absorbent contactor;

contacting in said second absorbent contactor in co-current flow at least a portion of said first partially scrubbed gas mixture with at least a portion of said second absorbent solution under conditions sufficient to cause absorption of at least a portion of said acid gas from said first partially scrubbed gas mixture; and

removing a stream of a second spent absorbent solution from said second absorbent contactor, which said second spent absorbent solution contains at least a portion of said acid gas from said first partially scrubbed gas mixture.

In more preferred embodiments, the absorbent contactor is comprised of a monolithic bed containing substantially parallel channels. In other preferred embodiments, the absorbent contactor is operated such that the conditions in the monolithic bed are at or near a Taylor flow or slug flow regime through said parallel channels.

In preferred embodiments, the absorbent solution is selected from the group consisting of: an amine solution comprising a primary amine, a secondary amine, or mixtures thereof; an amine solution comprising a polyamine or mixtures thereof; an alkali or alkaline earth metal hydroxide solution; and an alkali or alkaline earth metal carbonate solution.

As used herein, the term “acid gas” is defined as any gas mixture that is comprised of (contains) carbon dioxide (CO₂), hydrogen sulfide (H₂S) or a mixture thereof. Preferably, the acid gas herein is comprised of a “flue gas” (or “combustion gas”) that is the product of the combustion of hydrocarbons. In embodiments herein, most preferably, the acid gas contains carbon dioxide (CO₂).

As used herein, the term “absorbent contactor” (or “packed contactor” or “packed tower”) is defined as a vessel within which the gas mixture contacts the absorbent wherein within the vessel is at least one structured contacting means, such as vessel packing, trays, or monoliths. In preferred embodiments herein, the absorbent contactor vessel contains a monolith which allows the combined gas mixture/absorbent to flow through paths engineered within the monolith.

In other preferred embodiments, the monolithic beds have screens or inlets sufficient to operate the flow at or near a Taylor flow or slug flow regime through the absorbent contactor. The one or more monolithic beds function as a coalescer and a contactor.

The absorbent contactor is preferably operated under conditions sufficient for the one or more monolithic beds to demist the liquid droplets from vapor.

This disclosure yet further relates in part to a system for separating an acid gas component from a gas mixture comprising an acid gas, such method comprising:

at least one first ejector venturi nozzle;

at least one first absorbent contactor, wherein the at least one first ejector venturi nozzle is in flow communication with the at least one first absorbent contactor,

at least one second ejector venturi nozzle; and

at least one second absorbent contactor, wherein the at least one second ejector venturi nozzle is in flow communication with the at least one second absorbent contactor;

wherein the at least one first absorbent contactor is in flow communication with the at least one second ejector venturi nozzle and the at least one second absorbent contactor is in flow communication with the at least one first ejector venturi nozzle.

In an embodiment, the above system can further comprise multiple absorbent contactors in parallel. In another embodiment of the above system absorbent contactor is comprised of a monolithic bed containing substantially parallel channels. In other preferred embodiments, the absorbent contactor is operated such that the conditions in the monolithic bed are at or near a Taylor flow or slug flow regime through said parallel channels.

In preferred embodiments, the absorbent solution is selected from the group consisting of: an amine solution comprising a primary amine, a secondary amine, or mixtures thereof; an amine solution comprising a polyamine or mixtures thereof; an alkali or alkaline earth metal hydroxide solution; and an alkali or alkaline earth metal carbonate solution.

In other preferred embodiments of the methods and systems herein, the absorbent solution has an absorption capacity of at least about 0.05 millimoles of CO₂ absorbed per gram of absorbent solution. Preferably, the operating conditions in the absorbent contactors include a temperature from about 1° C. to about 95° C., and a pressure from about 0.5 bar to about 50 bar (absolute).

In other preferred embodiments of the methods and systems herein, the feed gas mixture further comprises at least one gas selected from the group consisting of: hydrocarbons, carbon monoxide, H₂, O₂, N₂, and combinations thereof. In other preferred embodiments, the feed gas mixture further comprises at least one hydrocarbon selected from the group consisting of: naphtha, methane, ethane, ethene, and combinations thereof.

This disclosure also relates in part to a system for separating an acid gas component from a gas mixture, such system comprising at least one ejector venturi nozzle in flow communication with at least one absorbent contactor.

This disclosure further relates in part to a system for separating an acid gas component from a gas mixture, such system comprising at least one liquid spray device in flow communication with at least one absorbent contactor, wherein said absorbent contactor contains one or more monolithic beds.

In an embodiment of the above system, the liquid spray device can comprise an ejector venturi nozzle. The monolithic beds can have screens or inlets sufficient to operate the flow at or near a Taylor flow or slug flow regime through said absorbent contactor. In addition, the monolithic beds can function as a coalescer and a contactor.

The systems and methods of this disclosure provide a low capital investment process for CO₂ capture with absorbent solutions, e.g., amines or other solutions that can affect the absorption of CO₂. The use of ejector venturi nozzles in the systems and methods of this disclosure eliminates the need for expensive fans/blowers for drafting a gas mixture, e.g., flue gas, into the absorbent contactors and to overcome the pressure drop in the contactors. The kinetic energy for overcoming the pressure drop comes from the high pressure liquid pumps, e.g., ejector venturi nozzles, which are significantly less expensive than fans/blowers. The co-current designs of the present invention also reduce the pressure drop through the systems. The systems and methods of this disclosure also reduce or eliminate the need for expensive demisters.

In addition, the absorbent contactors can have compact monoliths that operate in the Taylor flow or slug flow regime. The Taylor flow and slug flow regime monoliths have several advantages, for example, very low pressure drop, high mass transfer rates, effective demisting, and minimum back-mixing of gas and liquid flows. The Taylor flow and slug flow monoliths thus further reduce the need of fans/blowers or compressors.

Further objects, features and advantages of the present disclosure will be understood by reference to the following drawings and detailed description.

### BRIEF DESCRIPTION OF THE DRAWINGS

FIG. 1 is a schematic of an embodiment of a CO₂ capture process of the present invention using counter-staged venturi ejectors and contactors.

FIG. 2 is a schematic of an embodiment of a horizontal contactor of the present invention having monoliths and using a venturi ejector.

FIG. 3 is a schematic of an embodiment of a horizontal contactor of the present invention having monoliths and using a venturi ejector. Less liquid is present than in FIG. 2 and the liquid draw-off is positioned lower.

FIG. 4 is a schematic of an embodiment of a horizontal contactor of the present invention having structured packings and using a venturi ejector.

FIG. 5 is a schematic of an embodiment of a contactor of the present invention having monolith packing that operates in the Taylor flow or slug flow regime.

FIG. 6 illustrates the concept of Taylor flow.

FIG. 7 is a Computational Fluid Dynamics (CFD) illustration of the increasing void fraction of the gas phase as the liquid coalesces and drains out from the flow.

FIG. 8 is a sketch of observed flow regimes in capillary channels. For simplicity, co-current up-flow is shown. (a) and (b) bubbly flow, (c) and (d) Taylor flow, (e) transitional slug flow, (f) churn flow, and (g) and (h) film or annular flow.

FIG. 9 is a flow regime map of Suo and Griffith, 1964 for Ca/Re=1.5×10⁻⁵. This flow regime map correlates the flow regime with the Capillary number (Ca=μU_{g}/σ,.it represents the ratio of viscous and surface tension forces) and the liquid hold-up (Φ_{L}/Φ_{L}+Φ_{G}).

FIG. 10 is a flow regime map of Jayawardena, S. S., Balakotaiah, V., Witte, L., A.I.Ch.E. Journal 43 (6), 1637-1640, 1997. In flow regime map of Jayawardena et al., the flow regime is correlated with different dimensionless groups.

### DETAILED DESCRIPTION OF THE PREFERRED EMBODIMENT

The method of this disclosure involves removing CO₂ and/or H₂S, from a gaseous stream containing one or more of these gases using an absorption solution, such as an amine solution, as an absorbent. Other absorption solutions useful in this invention include, for example, caustic solutions such as hydroxides/carbonate solutions of an alkali/alkaline earth metals. The amine scrubbing is based on the selective absorption of a gas mixture and involves contacting the gas mixture with a selective absorbent under conditions sufficient to effect selective removal of CO₂ and/or H₂S. The absorption conditions (i.e., temperature and/or pressure) should be favorable for selectively absorbing a component of the gas mixture and producing an absorption effluent, which has reduced concentration of the absorbed component relative to the gas mixture. Subsequently, the absorbable component is then desorbed by stripping with an inert gas, gaseous CO₂, or steam, for example, in a regeneration tower. Under desorption conditions, the absorbable component is purged from the selective absorbent.

Once the absorbent has been formulated, it can be employed in a absorbent contactor as per the present invention to selectively remove CO₂ and/or H₂S from an acid gas. The absorbent(s) can be made by conventional processes. After the absorbent is produced, it is used, in a absorbent contactor, where a gaseous stream comprised of an acid gas (preferably containing CO₂) co-currently contacts the absorbent. With amine absorbents, the CO₂ and amine chemically react to form an amine complex, thereby removing the CO₂ from the gaseous stream.

After the absorbent is loaded with CO₂ to a satisfactory level, for example, when greater than 60 percent, or more preferably, greater than 80 percent of the amine has been converted to the amine complex, or at a designated cycle time, the sorbent can be regenerated. Regeneration involves desorbing the absorbed CO₂ typically by stripping with an inert gas, gaseous CO₂, or steam, for example, in a regeneration tower. During this step, the amine complex is dissociated and CO₂ removed, and the amine is freed and recycled into the absorption process.

In the method of this disclosure, ejector venturi nozzles are used to contact the gas mixture containing at least one acid gas (e.g., flue gas) with the absorbent (e.g., an amine solution). A major advantage of ejector venturi nozzles is that kinetic energy from the motive amine fluid is used to generate the gas mixture pressure required for drafting the gas mixture through the ejector venturi nozzle and absorbent contactor. This approach eliminates the need for expensive blowers/fans that would otherwise be needed in the conventional absorbent absorption towers.

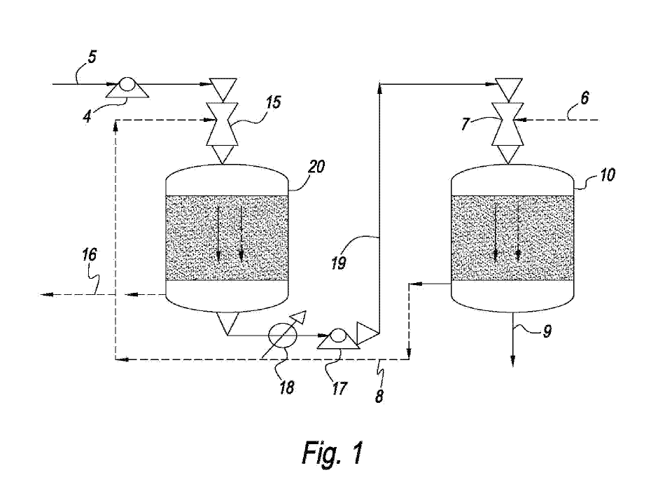

The absorbent contactors (or “contactors”) used in this disclosure can contain conventional packing, trays, structured packing, monoliths, and the like. The absorbent contactors used herein are comprised of structure packing or monoliths. Even more preferably, the absorbent contactors used herein are comprised of at least one monolith. The contactors may contain one or more monolith beds. As shown in FIG. 1, the contactors typically have a vertical configuration but can also have a horizontal configuration as described herein. In a horizontal configuration, the contactor can also function as a separator by allowing gravity to segregate the liquid and gas.

The method of this disclosure uses multiple counter-current stages with co-current flow in each stage. Due to the high amount of contaminant (e.g. H₂S) removal efficiency required in the current art, the use of counter-current flow towers have been utilized so as to maximize the driving force for mass transfer. While counter-current contacting maximizes the mass transfer driving force, it necessitates constraining the gas velocity to typically less than 10 feet/second so as to prevent tower flooding in counter-current operation. Given the very large volumes of flue gas, the required low gas velocity in the tower will lead to prohibitively large diameter and expensive towers.

While the bulk of the CO₂ preferably is removed (80-90% plus), the requirements for CO₂ removal may not be as stringent as that for H₂S. This disclosure describes the use of co-current contacting towers to remove acid gases (e.g., containing CO₂). Co-current contacting towers are not constrained by flooding, and significantly higher gas velocities (resulting in smaller diameter vessels) can be used. More importantly, multiple contactors are used such that while the gas flow is co-current, the injection of a liquid stream at several locations along the contactor length maintains sufficient mass transfer driving force. This arrangement gets closer to the inherent driving force efficiency offered by pure counter-current operation.

The method of this disclosure also permits interstage cooling of the amine absorbent. This allows a higher CO₂ capture capacity of the amine utilized. The process configuration in FIG. 1 allows for interstage cooling. The interstage lowering of amine temperature increases its absorption capacity, and thus a reduction in equipment size.

FIG. 1 is a schematic representation of a CO₂ capture process using counter-staged venturi ejectors and contactors. The CO₂ removal process involves two steps of amine-CO₂ contacting for CO₂ absorption into the amine absorbent followed by thermal regeneration of the amine and amine recycle. These absorption-regeneration steps are heat integrated to minimize energy usage.

The use of ejectors as shown in the FIG. 1 process configuration eliminates the need for expensive fan blowers for drafting the acid gas, e.g., flue gas, into the CO₂/amine contactors. The ejectors are also useful for overcoming the pressure drop in the contactors. The kinetic energy for overcoming the pressure drop comes from the high pressure liquid pumps, e.g., ejector venturi nozzles, which are significantly less expensive to purchase and operate than fans/blowers.

In accordance with this disclosure, the acid gas, e.g., flue gas, and liquid absorbent (amine) flow in a co-current manner in the absorbent contactors. The use of co-current contactors allows high gas velocities without any risk of flooding. This in turn allows the use of contactors with a smaller diameter. If conventional counter-current contactors were used, the gas velocity in the vessel would need to be constrained below a threshold level (typically about 10 feet/second) to prevent flooding of the contactors. In a flooded contactor, the high gas velocity of the upward flowing gas prevents the liquid from flowing downwards, and the amine does not contact the acid gas, e.g., flue gas.

In accordance with this disclosure and as shown in FIG. 1, the two absorbent contactors and two ejector venturi nozzles are arranged in a counter-current configuration in that the regenerated absorbent, e.g., regenerated amine solution, flows from the left contactor to the right ejector venturi nozzle, and the scrubbed acid gas, e.g., scrubbed flue gas, flows from the right contactor to the left ejector venturi nozzle. This counter-current configuration of the absorbent contactors increases the driving force for mass transfer while the co-current acid gas/absorbent flow within the absorbent contactors results in high available velocities. The ratio of gas volume to liquid volume in the gas mixture/absorbent flow should be sufficient to maintain the flow at conditions conducive to rapid mass transfer such as Taylor flow or slug flow regime through the absorbent contactors.

Referring to FIG. 1, a first ejector venturi nozzle 7 is provided in flow communication with a first absorbent contactor 10, and a second ejector venturi nozzle 15 is provided in flow communication with a second absorbent contactor 20. The first absorbent contactor 10 is in flow communication with the second ejector venturi nozzle 15 (via stream 8), and the second absorbent contactor 20 in flow communication with the first ejector venturi nozzle 7 (via stream 19). A stream 6 of a gas mixture containing at least one acid gas is flowed into the first ejector venturi nozzle 7. A stream 19 of a partially spent absorbent is also flowed into the first ejector venturi nozzle 7. At least a portion of the gas mixture containing at least one acid gas is contacted with at least a portion of the partially spent absorbent in the first ejector venturi nozzle 7 under conditions sufficient to cause absorption of at least a portion of the acid gas into the absorbent stream. A stream comprising liquid droplets is ejected from the first ejector venturi nozzle 7 and the liquid droplet stream is flowed into the first absorbent contactor 10. At least a portion of the gas mixture containing at least one acid gas is contacted with at least a portion of the absorbent in the first absorbent contactor 10 in co-current flow under conditions sufficient to cause absorption of at least a portion of the acid gas into the absorbent stream. A stream 8 of at least partially scrubbed acid gas is removed from the first absorbent contactor 10. A stream 9 of at least partially spent absorbent is removed from the first absorbent contactor 10, and the at least partially spent absorbent stream is treated under conditions sufficient to cause desorption of at least a portion of the acid gas and produce a regenerated absorbent.

A stream 8 of the at least partially scrubbed acid gas is flowed into the second ejector venturi nozzle 15. A stream 5 of the regenerated absorbent

More than two contactors may be used in series to further increase the mass transfer driving force. In the limit, the driving force will approach the contacting efficiency of gas-liquid counter-current flow in a contactor. Because the requirement for CO₂ removal from flue gas is not very stringent (80-90% CO₂ removal vs. traditional 99% plus H₂S removal in amine nozzles), it is anticipated that 2 absorber stages, as shown in FIG. 1, will be sufficient. Depending upon the percent CO₂ capture target, a single absorbent contactor may be adequate in some situations.

The CO₂-amine mass transfer area is provided by the ejectors (creation of small liquid droplets for mass transfer area) as well as by the absorbent contactors. Depending upon the selected amine and the kinetic rate of CO₂ reaction with the selected amine, absorbent contactors may not be necessary downstream of each ejector. However, in preferred embodiments of the present invention, at least one contactor will contain a monolith or packing through which the combined absorbent/gas mixture flow, which is illustrated as the gray portion of the contactor vessels shown in FIG. 1. The use of these contactor internal configurations result in improved mixing as well as improved coalesence and liquid spent absorbent removal under the absorbent process configurations and conditions disclosed herein. In such a situation, the ejector(s) alone may provide adequate mass transfer area to achieve the CO₂ removal targets.

FIG. 1 depicts an ejector upstream of each of the two contactors. It is within the scope of this disclosure to integrate the ejector with the contactor or to locate the ejector within the contactor. It is also within the scope of this disclosure to have multiple parallel ejectors to feed a contactor vessel, which multiple ejectors may be located at the contactor vessel entry or distributed along the length of the contactor vessel (not shown), or to have multiple contactors in parallel.

The high velocity liquid ejectors create small liquid droplets to facilitate vapor-liquid mass transfer. While the small droplets are desirable for mass transfer, the fine mist that has been created must be removed from the vapor or excessive amine loss would occur. In addition to providing additional mass transfer area, the co-current contactors also act as demisters. Thus, the configuration as shown in FIG. 1 reduces/eliminates the need for expensive demisters.

With degradation of amines and under certain operating conditions, fouling of the co-current absorbent contactors may possibly occur. Potential fouling can lead to an increase in pressure drop across the contactors. This can become a crucial operating variable because the ejectors can only generate a small increase in pressure, and only a very limited pressure drop is available in the ejector facilitated gas flow. Technology for automatically bypassing gas and liquid flows around the fouling layers of the packing can be used to mitigate the effect of fouling in co-current contactors. Such technology is described, for example, in U.S. Pat. No. 4,380,529 and U.S. Pat. No. 6,689,329, which are incorporated herein in their entirety.

The absorbents utilized in the method of this disclosure can be any liquid that can affect the absorption of an acid gas, e.g., CO₂. Preferably, the method of this disclosure uses high CO₂ capacity amine solutions. In other embodiments, the absorbent may be comprised of a caustic solutions selected from alkali or alkaline earth metal hydroxides, alkali or alkaline earth metal carbonates, or mixtures thereof.

The absorbent preferably comprises an amine solution. The amine solution comprises a primary amine, a secondary amine, or mixtures thereof. Polyamines having primary amine and/or secondary amine groups may also be useful in this disclosure. The absorbent may contain optional ingredients such as antioxidant, corrosion preventive, and the like.

Illustrative amines useful as absorbents in this disclosure include, for example, primary amines such as monoethanolamine (MEA), mixtures of primary amines, secondary amines such as diethanolamine (DEA) and diisopropylamine (DIPA), mixtures of secondary amines, mixtures of primary amines and secondary amines, polyamines having primary amine groups, mixtures of polyamines having primary amine groups, polyamines having secondary amine groups, mixtures of polyamines having secondary amine groups, mixtures of polyamines having primary amine groups and polyamines having secondary amine groups, and the like. The amines are conventional materials known in the art.

The concentration of the primary amine, secondary amine, or mixture of primary amine and secondary amine, in a solvent can vary over a wide range. The concentration of the primary amine with respect to the overall absorbent solution can range from about 1 weight percent to about 100 weight percent, preferably from about 20 weight percent to about 50 weight percent. The concentration of the secondary amine with respect to the overall absorbent solution can range from about 1 weight percent to about 100 weight percent, preferably from about 20 weight percent to about 50 weight percent. With regard to an absorbent comprising a mixture of a primary amine and secondary amine, the concentration of the mixture with respect to the overall absorbent solution can range from about 1 weight percent to about 99 weight percent, preferably from about 10 weight percent to about 90 weight percent.

It is understood that the absorbent is not limited to amine solutions. For example, any liquid that can affect the absorption of acid gas may be useful in this invention. Other illustrative absorbents include, for example, hydroxides/carbonate solutions of alkali/alkaline earth metals, and the like.

The absorbent material preferably has an absorption capacity of at least about 0.05 millimoles, more preferably at least about 0.5 millimoles, and even more preferably at least about 1.0 millimoles, of CO₂ absorbed per gram of absorbent when measured by a thermal gravimetric apparatus using a dry gas stream containing CO₂ (about 0.7 atmosphere partial pressure) and an inert gas. In addition, the absorbent preferably has a desorption rate, indicated by a first order rate constant, of about 0.0001 to about 10000 per minute, more preferably from about 0.01 to about 100 per minute, and even more preferably from about 0.1 to about 10 per minute, when measured by a thermal gravimetric apparatus using a dry inert gas stream to purge the sample. The absorbent can be regenerated from one cycle to another in cycling absorption processes, and thus the absorbent is cyclically stable.

For the absorption processes herein, the temperature is preferably in the range of from about 1° C. to about 95° C., more preferably from about 10° C. to about 75° C., and even more preferably between about 35° C. and about 55° C. The pressure is preferably in the range of from about 0.5 bar to about 50 bar (absolute), and more preferably from about 0.9 bar to about 25 bar (absolute). The partial pressure of carbon dioxide in the gas mixture is preferably from about 0.03 to about 20 bar, and more preferably from about 0.4 to about 10 bar (absolute). The gas mixture is preferably contacted co-currently with the absorbent material in the process configurations herein at a superficial velocity of from about 1 ft/sec to about 150 ft/sec, more preferably a superficial velocity of from about 5 ft/sec to about 100 ft/sec, and even more preferably a superficial velocity of from about 8 ft/sec to about 50 ft/sec. The gas mixture may be contacted with the absorbent material one or more times.

It is understood that the absorbent is not limited to use for the removal of CO₂ from a gaseous stream. Rather the absorbent can be used for the removal of H₂S, or and combination of CO₂ and H₂S, from a gaseous stream containing an acid gas, provided that the acid gas is capable of reaction with amines.

The carbon dioxide can be desorbed by means of stripping with an inert gas, gaseous CO₂, or steam preferably in a separate regeneration tower.

For CO₂ (or similarly H₂S) desorption in the processes herein, suitable pressures can range from about 500 mbar to about 200 bar (absolute), preferably from about 800 mbar to about 100 bar (absolute). The desorption temperature in these processes are preferably maintained in the range of from about 50° C. to about 250° C., more preferably from about 75° C. to about 175° C., and even more preferably greater than about 120° C.

For amine regeneration, the use of steam ejectors (possibly using low pressure refinery waste steam) can be used to lower amine regeneration pressure. This allows amine regeneration at a lower temperature and a reduction in the energy requirements for regeneration.

In convention processes, regeneration of the amine for recycle is an energy intensive process and a major component of the operating cost. Regenerating the amine at a lower temperature so as to reduce the energy costs would be highly desirable. It is within the scope of this disclosure to regenerate the amine under a lower temperature by reducing the pressure at which the regeneration is carried out. Steam injectors may be used to lower the pressure at which the regeneration is carried out. This will be particularly beneficial in a refinery environment where a large quantity of low pressure waste steam may be available.

In addition to the dual contactor scheme depicted in FIG. 1, the present invention includes embodiments using a single absorbent contactor. Here, at least one ejector venturi nozzle is provided in flow communication with a absorbent contactor. A stream of a gas mixture containing at least one acid gas and an absorbent is flowed into the ejector venturi nozzle. The absorbent is preferably an amine solution that can include a primary amine, a secondary amine, or mixtures thereof. At least a portion of the gas mixture containing at least one acid gas is contacted with at least a portion of the absorbent in the ejector venturi nozzle under conditions sufficient to cause absorption of at least a portion of the contaminants (e.g. CO₂) in the acid gas. A stream comprising liquid droplets is ejected from the ejector venturi nozzle and flowed into the absorbent contactor. At least a portion of the gas mixture containing at least one acid gas is contacted with at least a portion of the absorbent in the absorbent contactor in co-current flow under conditions sufficient to cause absorption of at least a portion of the acid gas. A stream of scrubbed acid gas is removed from the absorbent contactor. A stream of spent absorbent is removed from the absorbent contactor, and treated under conditions sufficient to cause desorption of at least a portion of the acid gas to produce a regenerated absorbent. The regenerated absorbent can be recycled to the ejector venturi nozzle.

As indicated above, this disclosure relates in part to a system for separating at least a portion of CO₂, H₂S or a combination thereof from a gas mixture comprising:

at least one first ejector venturi nozzle;

at least one first absorbent contactor, wherein the at least one first ejector venturi nozzle is in flow communication with the at least one first absorbent contactor,

at least one second ejector venturi nozzle; and

at least one second absorbent contactor, wherein the at least one second ejector venturi nozzle is in flow communication with the at least one second absorbent contactor;

wherein the at least one first absorbent contactor is in flow communication with the at least one second ejector venturi nozzle and the at least one second absorbent contactor is in flow communication with the at least one first ejector venturi nozzle.

The above system can further comprise multiple ejector venturi nozzles in parallel and multiple absorbent contactors in parallel as described herein.

This disclosure also relates in part to a system for separating an acid gas contaminants from a gas mixture comprising at least one ejector venturi nozzle in flow communication with at least one absorbent contactor.

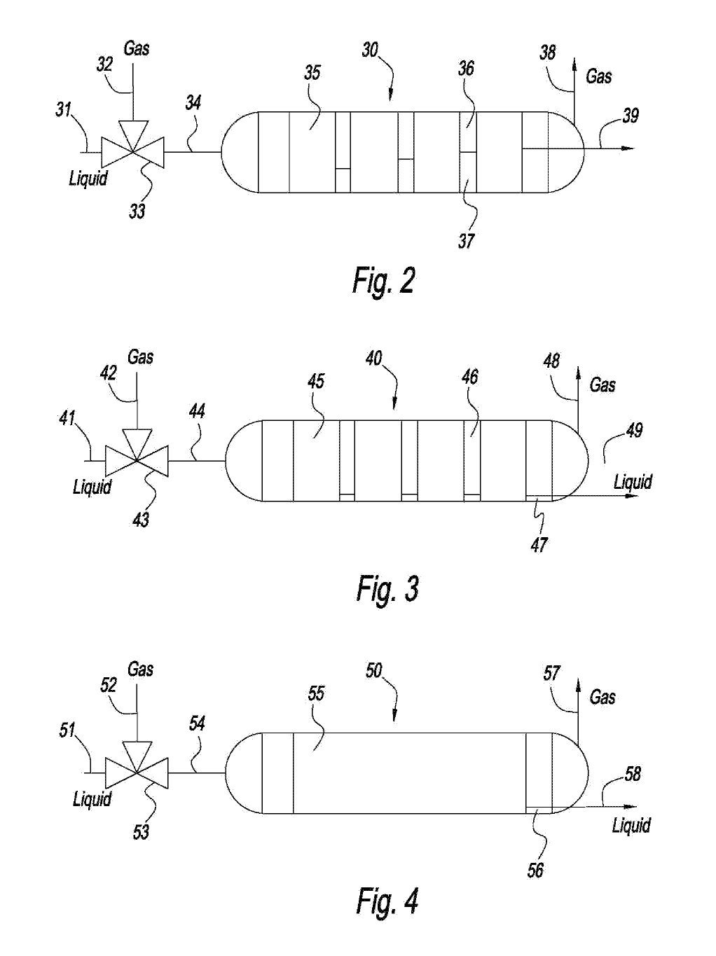

A variation of the scheme depicted in FIG. 1 is using a venturi ejector and horizontal contactor, which could have monoliths or structured packing. The advantage of such a configuration is that the initial surface area generation is achieved in the ejector, and that the horizontal contactor behaves not only as a contactor to finish the reaction, but also as a separation vessel, due to its horizontal positioning The structured packing or monoliths will act as demisters, while the horizontal position will allow gravity to effectively segregate the liquid and gas. In the event monoliths are used, a gap is typically needed between the monoliths at regular intervals. A schematic depiction is shown in FIG. 2. The amount of liquid relative to the gas will control the liquid level. In the schematic depiction shown in FIG. 3, less liquid is present and the liquid draw-off is positioned lower. In the schematic depiction shown in FIG. 4, structured packings are used.

Referring to FIG. 2, a liquid absorbent stream 31 enters an ejector venturi nozzle 33 at the side, and a gas mixture stream 32 containing at least one acid gas enters the ejector venturi nozzle 33 at the top. At least a portion of the gas mixture containing at least one acid gas is contacted with at least a portion of the regenerated absorbent in the ejector venturi nozzle 33 under conditions sufficient to cause absorption of at least a portion of the acid gas. A stream 34 comprising liquid droplets is ejected from the ejector venturi nozzle 33 and the liquid droplet stream is flowed into the absorbent contactor 30. At least a portion of the gas mixture containing at least one acid gas is contacted with at least a portion of the absorbent in contactor 30 in co-current flow under conditions sufficient to cause absorption of at least a portion of the acid gas. The advantage of such a configuration is that the initial surface area generation is achieved in ejector venturi nozzle 33, and that the horizontal contactor 30 behaves like a contactor to finish of the reaction, but also as a separation vessel, due to its horizontal positioning. The sections of monolith 35 act as demisters, while the horizontal position will allow gravity to effectively segregate the liquid absorbent and gas mixture. The contactor 30 contains sections of monolith 35 in which gaps 36 are necessary between the monoliths at regular intervals. The amount of liquid absorbent relative to the gas mixture will control the liquid levels 37. A stream 38 of scrubbed gas mixture is removed from contactor 30 at the top and a stream 39 of spent absorbent is removed from contactor 30 at about mid-level between top and bottom (i.e., below the liquid level). The stream 39 of spent absorbent can then be treated under conditions sufficient to cause desorption of at least a portion of the acid gas to produce a regenerated absorbent.

Referring to FIG. 3, a liquid absorbent stream 41 enters an ejector venturi nozzle 43 at the side, and a gas mixture stream 42 containing at least one acid gas enters the ejector venturi nozzle 43 at the top. At least a portion of the gas mixture containing at least one acid gas is contacted with at least a portion of the regenerated absorbent in the ejector venturi nozzle 43 under conditions sufficient to cause absorption of at least a portion of the acid gas. A stream 44 comprising liquid droplets is ejected from the ejector venturi nozzle 43 and the liquid droplet stream is flowed into the absorbent contactor 40. At least a portion of the gas mixture containing at least one acid gas is contacted with at least a portion of the absorbent in contactor 40 in co-current flow under conditions sufficient to cause absorption of at least a portion of the acid gas. The advantage of such a configuration is that the initial surface area generation is achieved in ejector venturi nozzle 43, and that the horizontal contactor 40 behaves like a contactor to finish of the reaction, but also as a separation vessel, due to its horizontal positioning The sections of monolith 45 act as demisters, while the horizontal position will allow gravity to effectively segregate the liquid absorbent and gas mixture. The contactor 40 contains sections of monolith 45 in which gaps 46 are necessary between the monoliths at regular intervals. The amount of liquid absorbent relative to the gas mixture will control the liquid levels 47. A stream 48 of scrubbed gas mixture is removed from contactor 40 at the top and a stream 49 of spent absorbent is removed from contactor 40 at the bottom (i.e., below the liquid level). Compared to FIG. 2, less liquid is present and the liquid draw-off 49 is positioned lower. The stream 49 of spent absorbent can then be treated under conditions sufficient to cause desorption of at least a portion of the acid gas to produce a regenerated absorbent.

Referring to FIG. 4, a liquid absorbent stream 51 enters an ejector venturi nozzle 53 at the side, and a gas mixture stream 52 containing at least one acid gas enters the ejector venturi nozzle 53 at the top. At least a portion of the gas mixture containing at least one acid gas is contacted with at least a portion of the regenerated absorbent in the ejector venturi nozzle 53 under conditions sufficient to cause absorption of at least a portion of the acid gas. A stream 54 comprising liquid droplets is ejected from the ejector venturi nozzle 53 and the liquid droplet stream is flowed into the contactor 50 having structured packing 55. At least a portion of the gas mixture containing at least one acid gas is contacted with at least a portion of the absorbent in contactor 50 in co-current flow under conditions sufficient to cause absorption of at least a portion of the acid gas. The advantage of such a configuration is that the initial surface area generation is achieved in ejector venturi nozzle 53, and that the horizontal contactor 50 behaves like a contactor to finish of the reaction, but also as a separation vessel, due to its horizontal positioning. The structured packing 55 acts as demisters, while the horizontal position will allow gravity to effectively segregate the liquid absorbent and gas mixture. The amount of liquid absorbent relative to the gas mixture will control the liquid levels 56. A stream 57 of scrubbed gas mixture is removed from contactor 50 at the top and a stream 58 of spent absorbent is removed from contactor 50 at the bottom (i.e., below the liquid level). The stream 58 of spent absorbent can then be treated under conditions sufficient to cause desorption of at least a portion of the acid gas to produce a regenerated absorbent.

The absorbent contactors can be comprised of compact monoliths that operate in the Taylor flow or slug flow regime. The Taylor flow and slug flow regime monoliths have several advantages, for example, very low pressure drop, high mass transfer rates, effective demisting, and minimum back-mixing of gas and liquid flows. The Taylor flow and slug flow monoliths thus further reduce the need of blowers/fans or compressors.

Taylor flow or slug flow is considered to be a desirable flow mode for “parallel channel” or “honeycomb” monoliths because they provides a relatively thin layer of solution against the channel walls past which the gas bubbles are conveyed. In addition, Taylor flow and slug flow provide good recirculation within the liquid plugs. The thin layer and good recirculation promote mass transfer in the monolithic material. The absorbent contactor maintains a desired volumetric gas to liquid volumetric ratio (G:L) (defined at the temperature and pressure of interest) in the monolith channels in order to maintain flow at or near the Taylor or slug regime. The Taylor flow and slug flow regimes occur under certain narrow conditions of volumetric G:L, nominally in a 1:1 ratio, although Taylor flow and slug flow in some circumstances may be observed at G:L ratios ranging from about 0.1 to about 10. At ratios near 1:1, the gas bubble is about the same size as the liquid slug.

As used herein, “parallel channel” (or “honeycomb”) monoliths are monolithic contactor internals that are comprised of multiple, segregated channels spanning from the inlet side of the monolith to the outlet side of the monolith that are substantially straight and substantially parallel. In contrast, as used herein for contactor internals, the term “packing” or “packed bed” means contactor internals for improving the contacting of the absorbent and the acid gas containing gas mixture, wherein the bed is not comprised of segregated channels from the inlet to the outlet of the bed, i.e., the flow channels throughout the bed are in fluid connection with other flow channels in the bed.

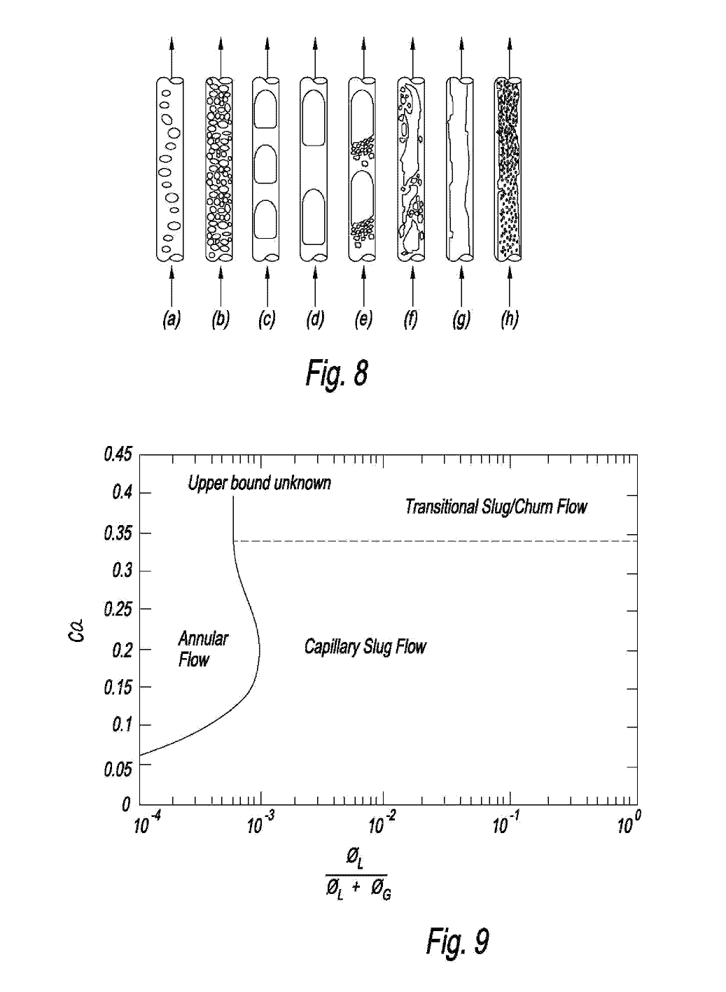

Taylor flow and slug flow are illustrated in FIG. 8. In Taylor flow, alternating bubbles of gas and liquid plugs travel through the monolith channels where there is an absence or very few gas bubbles present in the liquid plug. As used herein, slug flow means a gas/liquid flow in which there are small bubbles of gas present in the liquid slugs. Plug flow means a flow in which there are no, or comparatively few, gas bubbles in the liquid plug. Plug flow includes Taylor flow wherein the gas bubbles and liquid plugs are of the same order of magnitude in size. As used herein, when a flow is described as near or at the Taylor regime, it is meant that the flow is in a range where the limits are slug flow as illustrated in (e) of FIG. 8 and Taylor flow as illustrated in (c) and (d) of FIG. 8.

In an embodiment, the present invention uses co-current down-flow in the monoliths to eliminate the risk of flooding as can occur in counter-current absorber towers. A liquid spray nozzle is used to create very small drops that provide surface area for reaction with CO₂ gas.

Monoliths downstream of the spray nozzles operate in the Taylor flow or slug flow regime. The Taylor flow or slug flow, with its very high gas-liquid mass transfer rate and low pressure drop, provides additional CO₂ mass transfer, and demists the vapor. The feed to the monolith is a two phase gas-liquid mixture, and the droplet laden gas is converted into Taylor flow or slug flow. The monoliths can be used in combination with an ejector venturi. However, it is within the scope of the disclosure to use the monoliths alone without an ejector. Under some process conditions, the high mass transfer efficiency may provide adequate CO₂ capture efficiency even when an ejector is not used.

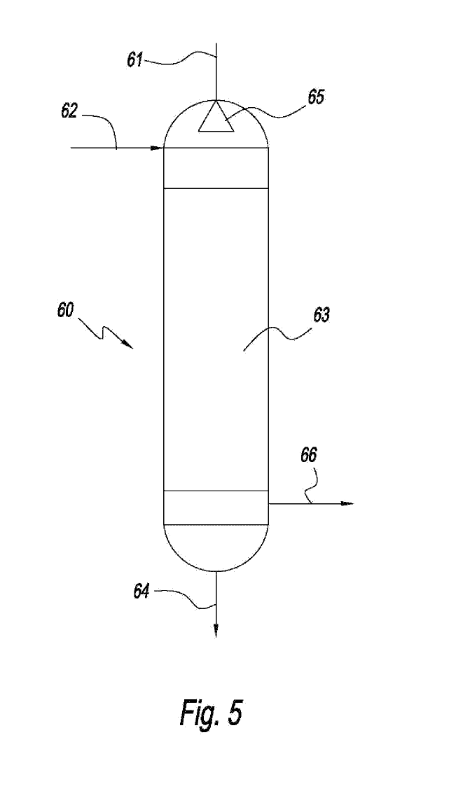

FIG. 5 is a schematic of a contactor 60 having a monolith 63 that operates in the Taylor flow or slug flow regime. A liquid absorbent stream 61 enters contactor 60 through the spray nozzle device 65 at the top, and a gas mixture stream 62 containing at least one acid gas enters contactor 60 at side. Alternatively, the gas mixture stream may be mixed with spray nozzle device 65 as well. The gas mixture and liquid absorbent are then subject to intense contacting in contactor 60 containing the monolith 63, which acts both as a coalescer and a contactor. Depending on the amounts of gas mixture and liquid absorbent added, and the droplet size (and therefore extent of reaction that occurs above the monolith), the monolith 63 can be either the coalescer or the contactor. For example, for large droplets, the reaction will not have progressed to completion or the desired target in the head space, and the monolith will create sufficient surface area and mass transfer. For very small droplets, the monolith will simply play the role of coalescer. Thus, the spray nozzle device 65 shown in FIG. 5, could be a simple liquid sprayer or a venturi ejector nozzle. A stream 66 of scrubbed gas mixture is removed from contactor 60 and a stream 64 of spent absorbent is removed from contactor 60 at the bottom. The stream 64 of spent absorbent can then be treated under conditions sufficient to cause desorption of at least a portion of the acid gas to produce a regenerated absorbent.

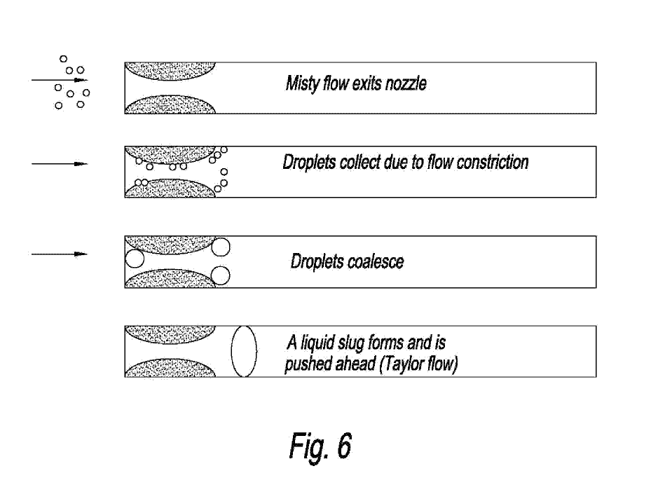

Taylor flow or slug flow promoters can be screens or special inlets to the monolith channels. FIG. 6 shows the concept of Taylor flow. For simplicity, flow has been shown as left-to-right, but typical flow configuration is from top-to-bottom. In FIG. 6, the misty droplet flow leaves inlet spray nozzle device, flow constrictions in every channel in the monolith create extra turbulence and coalesce drops, the drops pool together, and the pool gets drained as a slug.

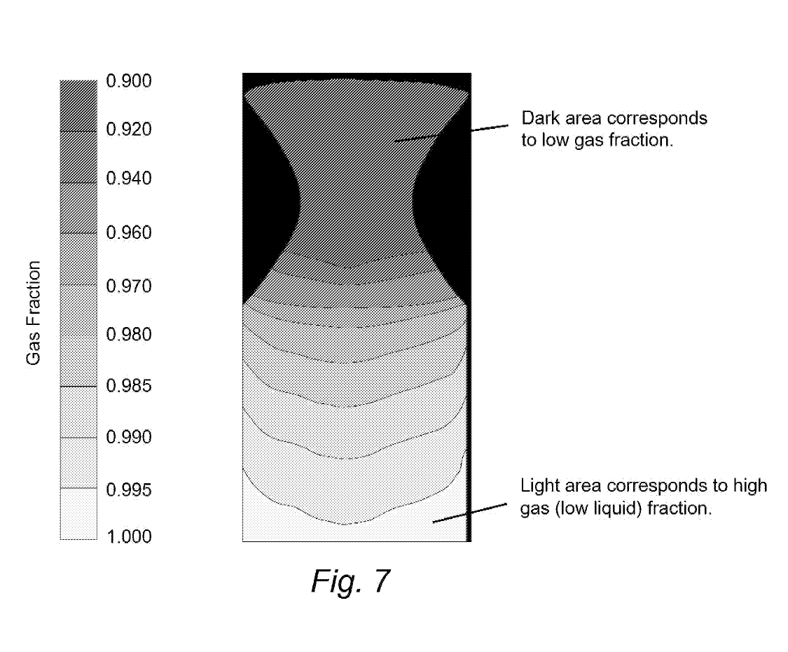

Steady state CFD simulations reveal that the shape indeed enhances the accumulation of liquid. FIG. 7 is a CFD illustration of the increasing void fraction of the gas phase as the liquid coalesces and drains out from the flow. The contrasting shades in the figure correspond to the void fraction of gas. The darker shades correspond to a low gas fraction, whereas the lighter shades correspond to high gas (low liquid) fraction. It is clear, that near the inlet, the gas has a high hold-up of liquid, but beyond the throat, the gas has deposited the liquid on the walls, which enhance the formation of a liquid slug.

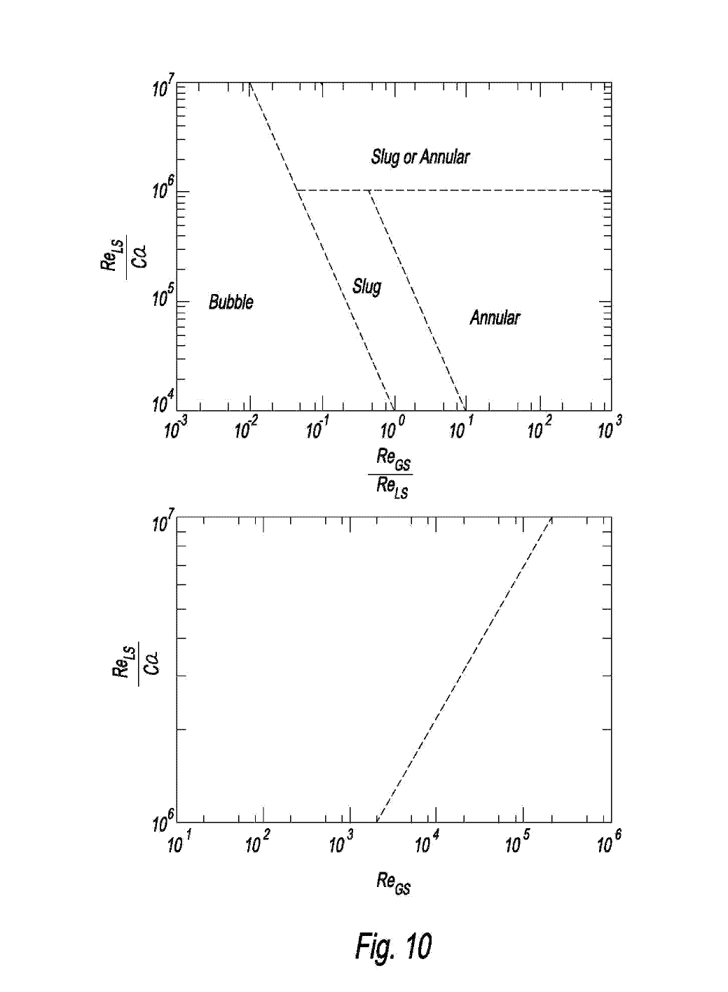

Flow regime maps for monoliths in up-flow, down-flow, etc. generally have regions for Taylor flow or slug flow as is shown in FIGS. 8, 9 and 10. FIG. 8 is a sketch of observed flow regimes in capillary channels. For simplicity, co-current up-flow is shown: (a) and (b) bubbly flow, (c) and (d) Taylor flow, (e) transitional slug flow, (f) churn flow, and (g) and (h) film or annular flow. The literature has a large number of flow regime maps, which predict the flow regime as a function of liquid and gas conditions and properties. FIG. 9 is a flow regime map of Suo and Griffith, 1964 for Ca/Re=1.5×10⁻⁵. This flow regime map correlates the flow regime with the Capillary number (Ca=μU_{g}/σ,.it represents the ratio of viscous and surface tension forces) and the liquid hold-up (Φ_{L}/Φ_{L}+Φ_{G}). Another flow regime map is shown in FIG. 10 after Jayawardena, S. S., Balakotaiah, V., Witte, L., A.I.Ch.E. Journal 43 (6), 1637-1640, 1997. In Jayawardena's flow regime map, the flow regime is correlated with different dimensionless groups.

As indicated herein, this disclosure relates in part to a system for separating an acid gas from a gas mixture comprising at least one liquid spray device in flow communication with at least one absorbent contactor, wherein said absorbent contactor contains one or more monolithic beds.

In the above system, the liquid spray device can comprise an ejector venturi nozzle. The monolithic beds can have screens or inlets sufficient to operate the flow at or near a Taylor flow or slug flow regime through said absorbent contactor. In addition, the monolithic beds can function as a coalescer and a contactor.

The gas mixture containing carbon dioxide can originate from a natural or artificial source. The gas mixture can contain in addition to carbon dioxide, one or more other gases such as methane, ethane, n-butane, i-butane, hydrogen, carbon monoxide, ethene, ethyne, propene, nitrogen, oxygen, helium, neon, argon, krypton, and hydrogen sulfide.

The constituents of the gas mixture may have different proportions. The amount of carbon dioxide in the gas mixture is preferably at least 1 percent, more preferably at least 10 percent, and even more preferably 50 percent or greater. The gas mixture can be any of a variety of gases, for example, natural gas, flue gas, fuel gas, waste gas and air.

The gas mixture and/or acid gas stream can be subject to dehumidification prior to contacting with the absorbent material. The dehumidification can be carried out by conventional methods. For example, the dehumidification can be carried out by absorption over solid sorbents. Preferred solid sorbents include, for example, molecular sieves, silica gels or aluminas.

In particular, water can be excluded from entering the system through the use of a drying agent/absorber guard bed upstream of the acid gas scrubbing unit, or by carrying out the CO₂ absorption at temperatures above 100° C. using an absorbent capable of being regenerated above the absorption temperature. Alternatively, this disclosure involves the use of an absorbent soluble, but water insoluble solvent to facilitate phase separation of the water entering with the flue gas being scrubbed.

It will be appreciated that conventional equipment can be used to perform the various functions of the amine scrubbing processes, such as monitoring and automatically regulating the flow of gases so that it can be fully automated to run continuously in an efficient manner.

Various modifications and variations of this disclosure will be obvious to a worker skilled in the art and it is to be understood that such modifications and variations are to be included within the purview of this application and the spirit and scope of the claims.

### EXAMPLE

For 66 million actual cubic feet per hour, sufficient area can be obtained, using model amines to result in reactor of approximately 8 meters diameter, and 8 meters tall to achieve 90% CO₂ absorption and Taylor flow or slug flow. The pressure drop is estimated to be less than 1 psi.

While we have shown and described several embodiments in accordance with our disclosure, it is to be clearly understood that the same may be susceptible to numerous changes apparent to one skilled in the art. Therefore, we do not wish to be limited to the details shown and described but intend to show all changes and modifications that come within the scope of the appended claims.

What is claimed is:

1. A method of separating an acid gas component from a feed gas mixture comprising an acid gas, such method comprising:
providing at least one liquid spray device in flow communication with at least one absorbent contactor, and at least one gas feed inlet line in flow communication with said at least one absorbent contactor, wherein said absorbent contactor is comprised of a at least one of a monolithic or packed bed;
contacting in said absorbent contactor in co-current flow at least a portion of a feed gas mixture containing at least one acid gas with at least a portion of a first absorbent solution under conditions sufficient to cause absorption of at least a portion of said acid gas, wherein said acid gas is comprised of CO₂, H₂S or a combination thereof;
removing a first partially scrubbed gas mixture from said absorbent contactor, wherein the molar concentration of acid gas in said first partially scrubbed gas mixture is less than the molar concentration of said acid gas in said feed gas mixture; and
removing a stream of a first spent absorbent solution from said absorbent contactor, which first spent absorbent solution contains at least a portion of the acid gas from the feed gas mixture.

2. The method of claim 1 wherein said liquid spray device comprises an ejector venturi nozzle.

3. The method of claim 2 wherein at least a portion of said feed gas mixture and a portion of said first absorbent solution passes through said ejector venturi nozzle.

4. The method of claim 1 wherein said absorbent contactor is comprised of a monolithic bed, which monolithic bed is comprised of substantially parallel channels.

5. The method of claim 4 wherein said absorbent contactor is operated such that the conditions in the monolithic bed are at or near a Taylor flow or slug flow regime through said parallel channels.

6. The method of claim 1 wherein said absorbent solution is selected from the group consisting of: an amine solution comprising a primary amine, a secondary amine, or mixtures thereof; an amine solution comprising a polyamine or mixtures thereof; an alkali or alkaline earth metal hydroxide solution; and an alkali or alkaline earth metal carbonate solution.

7. The method of claim 1 further comprising:
treating at least a portion of said first spent absorbent solution under conditions sufficient to cause desorption of at least a portion of said acid gas, thereby producing a first regenerated absorbent solution; and
recycling at least a portion of said first regenerated absorbent solution to said liquid spray device.

8. The method of claim 4 wherein said acid gas is CO₂.

9. A method of separating an acid gas component from a feed gas mixture comprising and acid gas, such method comprising:
providing at least a first ejector venturi nozzle in flow communication with at least a first absorbent contactor, and at least a second ejector venturi nozzle in flow communication with at least a second absorbent contactor; said first absorbent contactor in flow communication with said second ejector venturi nozzle and said second absorbent contactor in flow communication with said first ejector venturi nozzle;
ejecting a first ejector stream comprising liquid droplets from said first ejector venturi nozzle into said first absorbent contactor, said first ejector stream comprising a first absorbent solution and a first feed gas mixture containing at least one acid gas;
contacting in said first absorbent contactor in co-current flow at least a portion of said first feed gas mixture containing at least one acid gas with at least a portion of said first absorbent solution under conditions sufficient to cause absorption of at least a portion of said acid gas, wherein said acid gas is comprised of CO₂, H₂S or a combination thereof;
removing a first partially scrubbed gas mixture from said first absorbent contactor, wherein the molar concentration of said acid gas in said first partially scrubbed gas mixture is less than the molar concentration of said acid gas in said first feed gas mixture;
ejecting a second ejector stream comprising liquid droplets from said second ejector venturi nozzle into said second absorbent contactor, said second ejector stream comprising a second absorbent solution and a second feed gas mixture containing at least a portion of said first partially scrubbed gas mixture from said first absorbent contactor;
contacting in said second absorbent contactor in co-current flow at least a portion of said first partially scrubbed gas mixture with at least a portion of said second absorbent solution under conditions sufficient to cause absorption of at least a portion of said acid gas from said first partially scrubbed gas mixture; and
removing a stream of a second spent absorbent solution from said second absorbent contactor, which said second spent absorbent solution contains at least a portion of said acid gas from said first partially scrubbed gas mixture.

10. The method of claim 9 wherein further comprising:
removing a second partially scrubbed gas mixture from said second absorbent contactor, wherein the molar concentration of said acid gas in said second partially scrubbed gas mixture is less than the molar concentration of said acid gas in said first partially scrubbed gas mixture; and
recycling at least a portion of said second spent absorbent solution to said first ejector venturi nozzle.

10. The method of claim 9 wherein said first absorbent solution and said second absorbent solution are selected from the group consisting of: an amine solution comprising a primary amine, a secondary amine, or mixtures thereof; an amine solution comprising a polyamine or mixtures thereof; an alkali or alkaline earth metal hydroxide solution; and an alkali or alkaline earth metal carbonate solution.

11. The method of claim 9 wherein said second absorbent solution comprises a first regenerated absorbent solution that has been produced by treating said first spent absorbent solution from said first absorbent contactor under conditions sufficient to cause desorption of at least a portion of said acid gas from said first spent absorbent solution, thereby producing said first regenerated absorbent solution.

12. The method of claim 11 wherein said first absorbent contactor, said first ejector venturi nozzle, said second absorbent contactor and said second ejector venturi nozzle are arranged in a counter-current configuration in which said second spent absorbent solution flows from said second absorbent contactor to said first ejector venturi nozzle and said first partially scrubbed gas mixture flows from said first absorbent contactor to said second ejector venturi nozzle.

13. The method of claim 10 wherein the CO₂ content (by mol %) of said second partially scrubbed gas mixture is less than 20% of the CO₂ content (by mol %) of said feed gas mixture.

14. The method of claim 9 wherein said second spent absorbent solution from said second absorbent contactor is cooled prior to flowing into said first ejector venturi nozzle.

15. The method of claim 9 wherein said first absorbent contactor and said first absorbent contactor comprises a monolithic bed, wherein the monolithic bed is comprised of substantially parallel channels.

16. The method of claim 15 wherein at least one of said absorbent contactors is operated such that the conditions in the monolithic bed are at or near a Taylor flow or slug flow regime through said parallel channels.

17. The method of claim 15 wherein said feed gas mixture is preferably contacted co-currently with said first absorbent solution at a superficial velocity of from about 1 ft/sec to about 150 ft/sec.

18. The method of claim 9 wherein said absorbent solution has an absorption capacity of at least about 0.05 millimoles of CO₂ absorbed per gram of absorbent solution.

19. The method of claim 9 wherein the operating conditions in said first absorbent contactor and said second absorbent contactor include a temperature from about 1° C. to about 95° C., and a pressure from about 0.5 bar to about 50 bar (absolute).
